(19) United States
(12) Patent Application Publication
(10) Pub. No.: US 2025/0171026 A1
(43) Pub. Date: May 29, 2025

(54) COMPUTER SYSTEM AND METHOD FOR ASSISTING A VEHICLE IN TRAVERSING AN UPCOMING ROAD SEGMENT

(71) Applicant: Volvo Truck Corporation, Göteborg (SE)

(72) Inventors: Yann QUIBRIAC, Lyon (FR); Raphael RIBERO, Millery (FR)

(21) Appl. No.: 18/938,374

(22) Filed: Nov. 6, 2024

(30) Foreign Application Priority Data
Nov. 29, 2023 (EP) 23213057.5

(51) Int. Cl. B60W 30/18; B60W 10/20; B60W 60/00

(52) U.S. Cl. CPC B60W 30/18145; B60W 10/20; B60W 30/18109; B60W 60/001; B60W 2510/18; B60W 2510/20; B60W 2554/4042; B60W 2556/40

(57) ABSTRACT

A computer system comprising processing circuitry configured to obtain a driving difficulty of an upcoming road segment for a host vehicle of a vehicle type. The driving difficulty is based on at least one of: points of a multipoint turn of at least one vehicle of the vehicle type traversing the upcoming road segment; a width of a variability band of a plurality of turning trajectories of at least one vehicle of the vehicle type traversing the upcoming road segment. The processing circuitry is further configured to assist the host vehicle in traversing the upcoming road segment.

### PRIORITY APPLICATIONS

The present application claims priority to European Patent Application No. 23213057.5, filed on Nov. 29, 2023, and entitled “COMPUTER SYSTEM AND METHOD FOR ASSISTING A VEHICLE IN TRAVERSING AN UPCOMING ROAD SEGMENT,” which is incorporated herein by reference in its entirety.

### TECHNICAL FIELD

The disclosure relates generally to vehicles. In particular aspects, the disclosure relates to a computer system and a method for assisting a vehicle in traversing an upcoming road segment. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

While driving, a vehicle may need to traverse road segments requiring a high level of maneuvering skills. Particularly in urban areas narrow streets and complex intersections can be very difficult to traverse, especially if the vehicle is a heavy vehicle.

In view of the above problem there is a need for improvements applicable to vehicles in traversing road segments of increased driving difficulty.

### SUMMARY

According to a first aspect of the disclosure, a computer system is provided. The computer system comprises processing circuitry configured to: obtain a driving difficulty of an upcoming road segment for a host vehicle of a vehicle type, the driving difficulty based on at least one of: points of a multipoint turn of at least one vehicle of the vehicle type traversing the upcoming road segment; a width of a variability band of a plurality of turning trajectories of at least one vehicle of the vehicle type traversing the upcoming road segment. The processing circuitry is further configured to assist the host vehicle in traversing the upcoming road segment. The first aspect of the disclosure may seek to identify difficult road segments, and to make it easier for the vehicle to traverse the difficult road segment. A technical benefit may include improved identification of upcoming road segments having an increased driving difficulty, as well as facilitated traversing of such upcoming road segments.

Optionally in some examples, including in at least one preferred example, the points of a multipoint turn indicates forward and reverse operations by the host vehicle in traversing the upcoming road segment. A technical benefit may include using a simple and indicative approach to assess the driving difficulty.

Optionally in some examples, including in at least one preferred example, the width of the variability band indicates driving precision by the host vehicle in traversing the upcoming road segment. A technical benefit may include using another, yet simple approach to obtain the driving difficulty.

Optionally in some examples, including in at least one preferred example, assisting the host vehicle in traversing the upcoming road segment further comprises: obtain a preferred trajectory for the host vehicle, and assist the host vehicle by guiding the host vehicle along the preferred trajectory. A technical benefit may include using a best-mode trajectory as a reference, thereby optimizing the vehicle operation when traversing the upcoming road segment.

Optionally in some examples, including in at least one preferred example, assisting the host vehicle by guiding the host vehicle along the preferred trajectory further comprises at least one of: guide host vehicle by visualizing the preferred trajectory to the driver; guide the host vehicle by applying steering assist; or guide the host vehicle by applying at least partly autonomous driving. A technical benefit may include providing efficient, reliable, and easy to follow guidance along the road segment, whereby driving safety and efficiency is further improved.

Optionally in some examples, including in at least one preferred example, the processing circuitry is further configured to: obtain the preferred trajectory from a plurality of reference trajectories, wherein each reference trajectory corresponds to a trajectory of at least one vehicle of the vehicle type traversing the upcoming road segment. A technical benefit may include providing a reliable trajectory as reference, as this is determined from a number of previous traversals of the road segment.

Optionally in some examples, including in at least one preferred example, the processing circuitry is further configured to: obtain the variability band from the plurality of reference trajectories, and obtain the preferred trajectory based on the variability band. A technical benefit may include improved reliability in obtaining the most preferred trajectory for the road segment.

Optionally in some examples, including in at least one preferred example, the processing circuitry is further configured to: obtain the points of a multipoint turn from the plurality of reference trajectories, and obtain the preferred trajectory based on the total number of points of the multipoint turn for each reference trajectory. A technical benefit may also in this case include improved reliability in obtaining the most preferred trajectory for the road segment.

Optionally in some examples, including in at least one preferred example, obtaining the driving difficulty of an upcoming road segment for the host vehicle further comprises: obtain a steering angle spread of at least one vehicle of the vehicle type traversing the upcoming road segment from the points of the multipoint turn and/or from the width of the variability band, and obtain the driving difficulty based on the steering angle spread. A technical benefit may include using a simple parameter for obtaining the driving difficulty.

Optionally in some examples, including in at least one preferred example, obtaining the driving difficulty of an upcoming road segment for the host vehicle further comprises: obtain a total number of braking operations of at least one vehicle of the vehicle type traversing the upcoming road segment, and obtain the driving difficulty based on the total number of braking operations. A technical benefit may also in this case include using a simple parameter for obtaining the driving difficulty.

Optionally in some examples, including in at least one preferred example, obtaining the driving difficulty of an upcoming road segment for the host vehicle further comprises: obtain the maximum and/or minimum speed of at least one vehicle of the vehicle type traversing the upcoming road segment, and obtain the driving difficulty based on the maximum and/or minimum speed. A technical benefit may include using a simple and easy retrievable parameter for obtaining the driving difficulty.

Optionally in some examples, including in at least one preferred example, obtaining the driving difficulty of an upcoming road segment for the host vehicle further comprises: obtain a relationship between the maximum and/or minimum speed of at least one vehicle of the vehicle type traversing the upcoming road segment and the maximum speed limit for the upcoming road segment, and obtain the driving difficulty based on the relationship. A technical benefit may include using an indicative and easy retrievable parameter for obtaining the driving difficulty.

Optionally in some examples, including in at least one preferred example, the processing circuitry is further configured to: indicate the upcoming road segment on a map of the host vehicle. A technical benefit may include notifying the driver of upcoming road segments of increased driving difficulty, thereby allowing the driver to choose another route to avoid the road segment.

Optionally in some examples, including in at least one preferred example, the processing circuitry is further configured to: indicate the driving difficulty of the upcoming road segment on a map of the host vehicle. A technical benefit may include notifying the driver of how different difficulty levels in the vicinity of the host vehicle, thereby allowing for improved route planning by the driver.

Optionally in some examples, including in at least one preferred example, the processing circuitry is further configured to: obtain a skill level of the driver of the associated vehicle, and to obtain the driving difficulty based on the driver's skill level. A technical benefit may include a more accurate and personalized obtaining of the driving difficulty.

Optionally in some examples, including in at least one preferred example, the points of a multipoint turn indicates forward and reverse operations by the host vehicle in traversing the upcoming road segment, the width of the variability band indicates driving precision by the host vehicle in traversing the upcoming road segment, assisting the host vehicle in traversing the upcoming road segment further comprises: obtain a preferred trajectory for the host vehicle, and assist the host vehicle by guiding the host vehicle along the preferred trajectory, assisting the host vehicle by guiding the host vehicle along the preferred trajectory further comprises at least one of: guide host vehicle by visualizing the preferred trajectory to the driver; guide the host vehicle by applying steering assist; or guide the host vehicle by applying at least partly autonomous driving, wherein the processing circuitry is further configured to: obtain the preferred trajectory from a plurality of reference trajectories, wherein each reference trajectory corresponds to a trajectory of at least one vehicle of the vehicle type traversing the upcoming road segment, wherein the processing circuitry is further configured to: obtain the variability band from the plurality of reference trajectories, and obtain the preferred trajectory based on the variability band, wherein the processing circuitry is further configured to: obtain the points of a multipoint turn from the plurality of reference trajectories, and obtain the preferred trajectory based on the total number of points of the multipoint turn for each reference trajectory, wherein obtaining the driving difficulty of an upcoming road segment for the host vehicle further comprises: obtain a steering angle spread of at least one vehicle of the vehicle type traversing the upcoming road segment from the points of the multipoint turn and/or from the width of the variability band, and obtain the driving difficulty based on the steering angle spread, wherein obtaining the driving difficulty of an upcoming road segment for the host vehicle further comprises: obtain a total number of braking operations of at least one vehicle of the vehicle type traversing the upcoming road segment, and obtain the driving difficulty based on the total number of braking operations, wherein obtaining the driving difficulty of an upcoming road segment for the host vehicle further comprises: obtain the maximum and/or minimum speed of at least one vehicle of the vehicle type traversing the upcoming road segment, and obtain the driving difficulty based on the maximum and/or minimum speed, wherein obtaining the driving difficulty of an upcoming road segment for the host vehicle further comprises: obtain a relationship between the maximum and/or minimum speed of at least one vehicle of the vehicle type traversing the upcoming road segment and the maximum speed limit for the upcoming road segment, and obtain the driving difficulty based on the relationship, wherein the processing circuitry is further configured to: indicate the upcoming road segment on a map of the host vehicle, wherein the processing circuitry is further configured to: indicate the driving difficulty of the upcoming road segment on a map of the host vehicle, wherein the processing circuitry is further configured to: obtain a skill level of the driver of the associated vehicle, and to obtain the driving difficulty based on the driver's skill level, wherein the processing circuitry is further configured to store traversing data of the host vehicle traversing the road segment.

According to a second aspect of the disclosure, a vehicle is provided. The vehicle comprises the computer system of the first aspect. The second aspect of the disclosure may seck to identify difficult road segments, and to make it easier for the vehicle to traverse the difficult road segment. A technical benefit may include improved identification of upcoming road segments having an increased driving difficulty, as well as facilitated traversing of such upcoming road segments.

According to a third aspect of the disclosure, a computer-implemented method is provided. The computer-implemented method comprises: obtaining, by processing circuitry of a computer system, a driving difficulty of an upcoming road segment for a host vehicle of a vehicle type, the driving difficulty based on at least one of: points of a multipoint turn of at least one vehicle of the vehicle type traversing the upcoming road segment; a width of a variability band of a plurality of turning trajectories of at least one vehicle of the vehicle type traversing the upcoming road segment. The method further comprises assisting the host vehicle in traversing the upcoming road segment. The third aspect of the disclosure may seek to identify difficult road segments, and to make it easier for the vehicle to traverse the difficult road segment. A technical benefit may include improved identification of upcoming road segments having an increased driving difficulty, as well as facilitated traversing of such upcoming road segments.

Optionally in some examples, including in at least one preferred example, assisting the host vehicle in traversing the upcoming road segment further comprises: obtaining a preferred trajectory for the host vehicle, and assisting the host vehicle by guiding the host vehicle along the preferred trajectory. A technical benefit may include using a best-mode trajectory as a reference, thereby optimizing the vehicle operation when traversing the upcoming road segment.

According to a fourth aspect of the disclosure, a computer program product is provided. The computer program product comprises program code for performing, when executed by a processing circuitry, the method of the third aspect.

According to a fifth aspect of the disclosure, a non-transitory computer-readable medium is provided. The non-transitory computer-readable medium comprises instructions, which when executed by a processing circuitry, cause the processing circuitry to perform the method of the third aspect.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1 is an exemplary side view of a host vehicle according to an example.

FIGS. 2A-B are exemplary diagrams of an assist system according to different examples.

FIG. 3A is a schematic view of a graphical user interface of a host vehicle according to an example.

FIG. 3B is a schematic view of a graphical user interface of a host vehicle according to an example.

FIGS. 4-6 are top views of a host vehicle traversing road segments according to different examples.

FIG. 7 is a driver's view in a host vehicle approaching a road segment according to an example.

FIG. 8 is a flow chart of an exemplary method to assist a host vehicle in traversing an upcoming road segment according to an example.

FIG. 9 is a schematic diagram of an exemplary computer system for implementing examples disclosed herein, according to an example.

### DETAILED DESCRIPTION

The detailed description set forth below provides information and examples of the disclosed technology with sufficient detail to enable those skilled in the art to practice the disclosure.

The examples presented herein provide a solution to improve driving of a host vehicle, in particular a heavy duty vehicle such as a truck, a bus, etc. which normally require a significant amount of maneuver space. To handle narrow traffic situations, such as tight corners, the host vehicle obtains a driving difficulty for an upcoming road segment. The driving difficulty is based on previous traversals of the upcoming road segment by one or more vehicles of the same vehicle type as the host vehicle. Once the driving difficulty is obtained, the host vehicle is assisted in traversing the upcoming road segment.

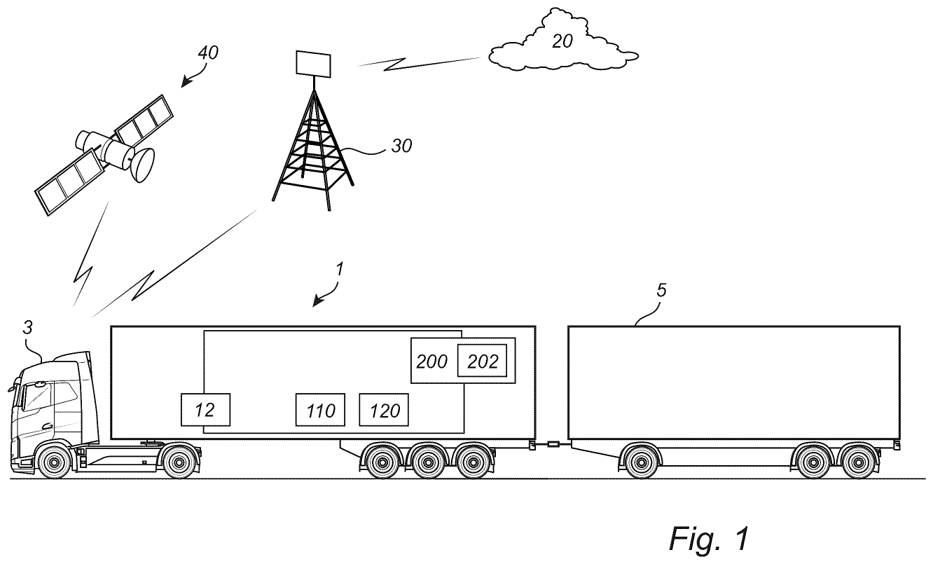

FIG. 1 is an exemplary side view of a host vehicle 1 according to one example. The host vehicle 1, herein the form of a truck, may or may not be an articulated vehicle. In the shown example the truck 1 comprises a tractor unit 3 and a trailer 5 being pulled by the tractor unit 3. The host vehicle 1 is programmed to assist the driver in traversing an upcoming road segment 7 based on a driving difficulty DD, as will be described further in the following. For this purpose the host vehicle 1 comprises, at least to some extent, processing circuitry 110 forming part of a computer system 100 (see FIG. 10). The processing circuitry 110 is configured to implement an assist system 200.

The host vehicle 1 may further comprise communications circuitry 12 configured to receive and/or send communication. The communications circuitry 12 may be configured to enable the host vehicle 1 to communicate with one or more external devices or systems such as a cloud server 20. The communication with the external devices or systems may be directly or via a communications interface such as a cellular communications interface 30, such as a radio base station. The cloud server 20 may be any suitable cloud server exemplified by, but not limited to, Amazon Web Services (AWS), Microsoft Azure, Google Cloud Platform (GCP), IBM Cloud, Oracle Cloud Infrastructure (OCI), DigitalOcean, Vultr, Linode, Alibaba Cloud, Rackspace etc. The communications interface may be a wireless communications interface exemplified by, but not limited to, Wi-Fi, Bluetooth, Zigbee, Z-Wave, LoRa, Sigfox, 2G (GSM, CDMA), 3G (UMTS, CDMA2000), 4G (LTE), 5G (NR) etc. The communication circuitry 12 may, additionally or alternatively, be configured to enable the host vehicle 1 to be operatively connected to a Global Navigation Satellite System (GNSS) 40 exemplified by, but not limited to, global positioning system (GPS), Globalnaya Navigatsionnaya Sputnikovaya Sistema (GLONASS), Galileo, BeiDou Navigation Satellite System, Navigation with Indian Constellation (NavIC) etc. The host vehicle 1 may be configured to utilize data obtain from the GNSS 40 to determine a geographical location of the host vehicle 1.

The host vehicle 1 in FIG. 1 comprises the computer system 100 and the assist system 200. The computer system 100 may be operatively connected to the assist system 200 and the communications circuitry 12 of the host vehicle 1. The computer system 100 comprises processing circuitry 110. The computer system 100 may comprise a storage device 120, advantageously a non-volatile storage device such as a hard disk drives (HDDs), solid-state drives (SSDs) etc. In some examples, the storage device 120 is operatively connected to the computer system 100. The assist system 200 may comprise assist system processing circuitry 202; the assist system processing circuitry 202 may be part of the processing circuitry 110 of the computer system 100.

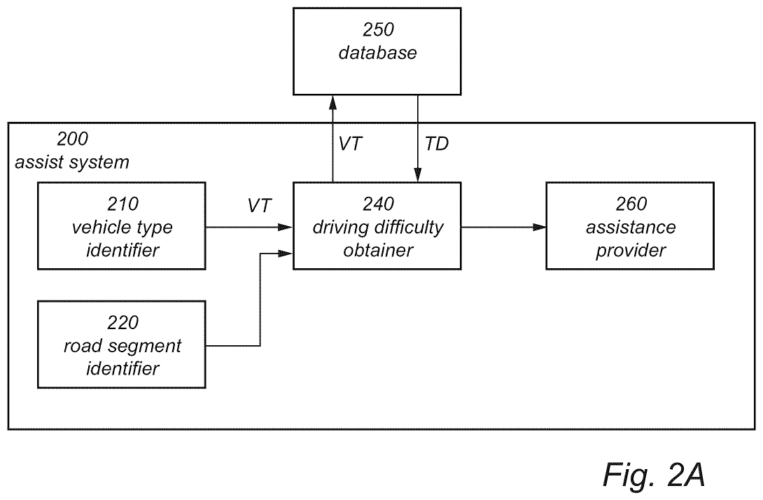

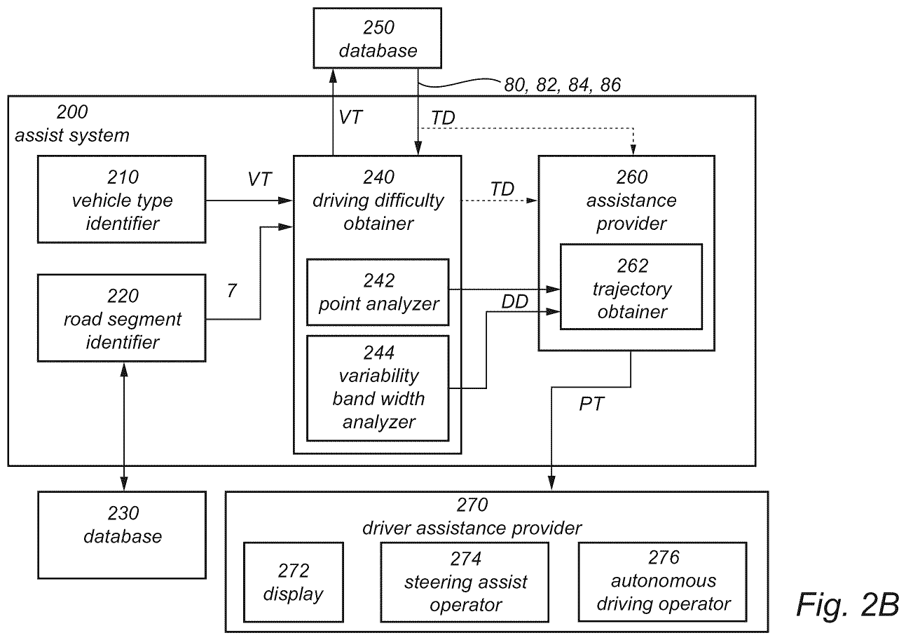

FIG. 2A is an exemplary block diagram of an architecture of an assist system 200, which is capable of assisting the host vehicle 1 in traversing the upcoming road segment 7. The computer system 100 is preferably configured to provide the functions and features of the assist system 200.

The assist system 200 comprises a vehicle type identifier 210. The vehicle type identifier 210 is configured to identify the vehicle type VT of the host vehicle 1. The vehicle type VT may be obtained in various ways and at various levels. For example, at a highest level the vehicle type identifier 210 may be configured to identify the host vehicle type VT as being one of a passenger car, a truck, or a bus. At a lowest level, the vehicle type identifier 210 applies a much higher resolution such that the vehicle type VT may be identified as a specific type having substantially the same physical properties as the host vehicle 1.

Physical properties of the host vehicle 1 may be used to identify the type VT of the host vehicle 1. Examples of physical properties that may be used are the length of the host vehicle 1, if the host vehicle 1 is articulated or rigid, the distance between the front and rear axles of the host vehicle 1, if the host vehicle 1 has any liftable wheel axle or not, if the host vehicle 1 allows for rear axle steering or not, if the host vehicle 1 is a conventional truck or a cab over engine truck, etc. Such physical properties, used by the vehicle type identifier 210 to identify the vehicle type VT, may be stored in a memory and accessed by the vehicle type identifier 210. Optionally, or in combination with stored data, one or more physical properties may be obtained by various hardware and/or software. Such hardware and/or software may be incorporated in the vehicle type identifier 210 or it may be separate components in communication with the vehicle type identifier 210. For example, the hardware and/software used to determine one or more physical properties of the host vehicle 1 may comprise image processing services, sensors, etc.

The assist system 200 further comprises a road segment identifier 220. The road segment identifier 220 is configured to identify at least one upcoming road segment 7 of the host vehicle 1. Typically, the at least one upcoming road segment 7 is a part of a planned route of the host vehicle 1, or a part of road segments 7 within a specified distance from the location of the host vehicle 1.

The assist system 200 also comprises a driving difficulty obtainer 240. The driving difficulty obtainer 240 is configured to obtain a driving difficulty DD of an upcoming road segment 7 for the host vehicle 1. In order to obtain the driving difficulty DD, the driving difficulty obtainer 240 has access to traversing data TD of vehicles of the same vehicle type VT previously traversing the upcoming road segment 7.

The assist system 200 is in communication with a database 250 which may or may not form part of the assist system 200. The database 250 stores such previous traversing data TD, not necessarily linked to any specific upcoming road segment 7.

The driving difficulty obtainer 240 is configured to, from the traversing data TD, obtain a driving difficulty DD of a certain upcoming road segment 7. The driving difficulty DD may be based on points of a multipoint turn in the traversing data TD. Hence, if the traversing data TD comprises information representing a multipoint turn at a specific location, this will indicate a driving difficulty DD of the upcoming road segment 7 at that specific location.

Optionally, or in combination, the driving difficulty DD may be based on a width of a variability band of a plurality of turning trajectories in the traversing data TD. Hence, if the traversing data TD comprises information representing multiple turning trajectories for vehicles traversing the same road segment, the width of the variability band for these multiple turning trajectories will indicate a driving difficulty DD of the upcoming road segment 7 containing that specific location.

The assist system 200 further comprises an assistance provider 260. Based on the determined driving difficulty DD for an upcoming road segment 7, the assistance provider 260 is configured to assist the host vehicle 1 in traversing the upcoming road segment 7.

A more detailed example of an assist system 200 is shown in FIG. 2B. The road segment identifier 220 is configured to identify an upcoming road segment 7 for the host vehicle 1. The road segment identifier 220 may identify road segments 7 as described with reference to FIG. 2A, i.e. identify all road segments 7 forming part of the planned route of the host vehicle 1, and/or identify all road segments 7 within a specified radius from the location of the host vehicle 1. Optionally, the road segment identifier 220 may identify all road segments 7 that are located within a specific time from the location of the host vehicle 1. The specific time may be determined based on normal traffic conditions, the maximum allowed speed, etc.

Optionally, road segments 7 to be identified may be pre-stored in a database 230. The database 230 may form part of the assist system 200, or it may be a separate and remote data structure being accessed by the assist system 200. The database 230 is according to one example storing road segments 7 of assumed, and/or previously determined increased driving difficulty. Pre-stored road segments 7 may improve processing speed of the assist system 200.

Assumed increased driving difficulty may be determined based on one or more of a plurality of parameters. Once a road segment 7 is identified as being associated with a driving difficulty DD, the coordinates of that road segment 7 may be stored in the database 230. Optionally, for example, if a certain road segment is often causing traffic to slow down, this may indicate increased driving difficulty whereby the road segment 7 is stored. In another example, if a certain road segment comprises a narrow street, this may indicate increased driving difficulty whereby the road segment 7 is stored. In a yet further example, certain road segments may be manually set as having an increased driving difficulty by drivers, traffic planners, etc.

The assist system 200 of FIG. 2B further comprises the driving difficulty obtainer 240. The driving difficulty obtainer 240 is configured to obtain a driving difficulty DD for one or more upcoming road segments 7. Preferably, each upcoming road segment 7 identified by the road segment identifier 220 is assessed.

The driving difficulty DD is obtained based on the identified road segment 7 and the identified vehicle type VT. As previously described with reference to FIG. 2A, the driving difficulty obtainer 240 is configured to determine the driving difficulty DD from previous traffic situations. Specifically, the driving difficulty DD is obtained by analyzing traversing data TD from at least one vehicle of the same vehicle type VT as the host vehicle 1 when traversing the upcoming road segment 7. The driving difficulty DD may be obtained by analyzing traversing data TD from the host vehicle 1 during a previous traversing of the upcoming road segment 7, or from another vehicle than the host vehicle 1. For a road segment 7 associated with a driving difficulty DD, the traversing data TD comprises information representing points of a multipoint turn and/or a width of a variability band of a plurality of turning trajectories. For this purpose, the driving difficulty obtainer 240 comprises a point analyzer 242 and/or a variability band width analyzer 244.

Traversing data TD may be stored in the database 250, in this embodiment forming a second database. The second database 250 may form part of the assist system 200 or it may be a separate and remote data structure being accessed by the assist system 200. The second database 250 may be incorporated in the first database 230 or these databases 230, 250 may be separate data structures. The second database 250 stores traversing data TD from one or more vehicles traversing the upcoming road segment 7. Although the assist system 200 will be able to operate with only one record of traversing data TD, the assist system 200 will benefit from a larger amount of stored records in terms of accuracy and reliability. Preferably, the second database 250 stores, for each road segment 7 and for each vehicle type VT, traversing data TD from a plurality of traversing trajectories.

The driving difficulty obtainer 240 may be configured to determine the driving difficulty DD from the most relevant traversing data TD in terms of vehicle type VT. In such example traversing data TD may be missing for the specific vehicle type VT of the host vehicle 1, and traversing data TD for another vehicle type VT, being determined to be at least somewhat similar to the host vehicle 1, may consequently be selected. Further, as an example only, if a driving difficulty DD is obtained for a specific upcoming road segment 7 based on a specific vehicle type VT being shorter than the host vehicle 1, the assist system 200 may obtain the same driving difficulty DD for the host vehicle 1 even if traversing data TD is missing for the exact vehicle type VT of the host vehicle 1.

The assist system 200 further comprises the assistance provider 260. Based on the obtained driving difficulty DD, the assistance provider 260 is configured to assist the host vehicle 1 in traversing the upcoming road segment 7. The determined driving difficulty DD may be a binary value, i.e. the determined driving difficulty DD of the upcoming road segment 7 may be determined as either existing or non-existing. In other examples the obtained driving difficulty DD for the upcoming road segment 7 is any number of a specific scale, such as between 0 and 100 where 0 indicates non-existing driving difficulty DD and 100 indicates maximum driving difficulty DD.

The assistance provider 260 comprises a trajectory obtainer 262 being configured to determine a preferred trajectory PT through the upcoming road segment 7. The preferred trajectory PT is preferably based on the traversing data TD, accessed either directly from the second database 250 or via the driving difficulty obtainer 240, as well as on the obtained driving difficulty DD. Optionally, the preferred trajectory PT may also be based on the vehicle type VT of the host vehicle 1.

The preferred trajectory PT is used by a driver assistance provider 270. The driver assistance provider 270 may form part of the assist system 200, or it may be a separate service of the host vehicle 1 which is controlled by the assist system 200 by the assist system 200 providing the required input.

The driver assistance provider 270 comprises a display 272, a steering assist operator 274, and/or an autonomous driving operator 276. As the preferred trajectory PT is transmitted to the driver assistance provider 270, the driver of the host vehicle 1 will be assisted in traversing the upcoming road segment 7 along the preferred trajectory PT by the display 272 visualizing the preferred trajectory PT to the driver of the host vehicle 1, by the steering assist operator 274 applying steering assist through the upcoming road segment 7, and/or by the autonomous driving operator 276 applying at least partly autonomous driving through the upcoming road segment 7.

Optionally, the host vehicle 1 may be configured to record the trajectory when the host vehicle 1 is traversing the road segment 7, and the assist system 200 may be configured to store the recorded trajectory as traversing data TD. In such example, additional reference data will be provided for future vehicles approaching the same road segment 7.

In a further example, the assist system 200 may be configured to obtain a skill level of the driver of the host vehicle 1. The skill level may be manually inputted by the driver before take-off, or it may be determined during driving of the host vehicle 1. If a skill level of the driver is obtained, the driving difficulty obtainer 240 may utilize this parameter when obtaining the driving difficulty DD of the road segment 7.

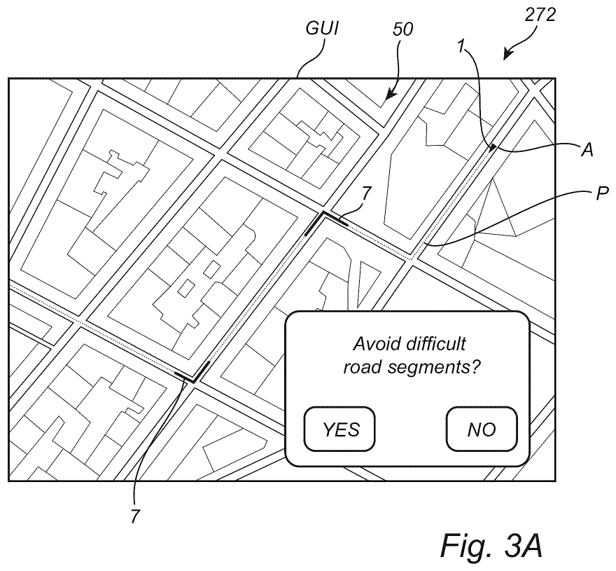

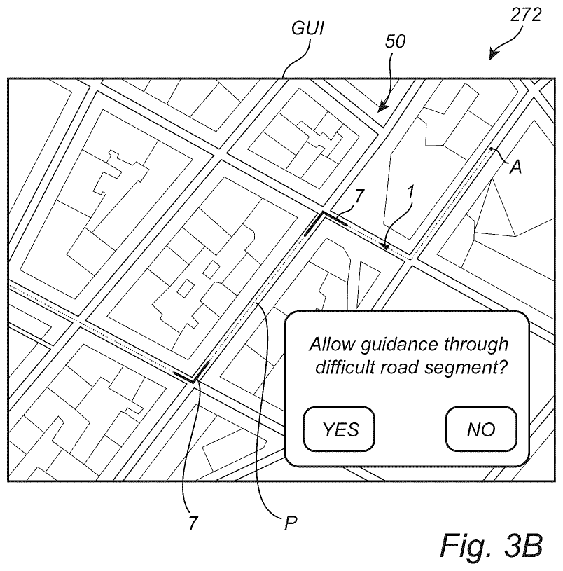

In FIG. 3A an example of a graphical user interface GUI of the host vehicle 1 is shown. The graphical user interface GUI is configured to show a map 50 on a display 272 of the host vehicle 1. The map 50 is dynamic, i.e. it shows the current position A of the host vehicle 1 as well as a planned route P, indicated by the dashed line in FIG. 3A, of the host vehicle 1.

The graphical user interface GUI is further configured to indicate upcoming road segments 7 for which a driving difficult DD has been obtained. As is shown in FIG. 3A, the driver may be prompted by the graphical user interface GUI to manually decide, by appropriate input to the graphical user interface GUI, if a route planner of the host vehicle 1 is allowed to include upcoming road segments 7 for which a driving difficulty has been obtained. In the shown example, the planned route P comprises two upcoming road segments 7. If the driver decides to avoid these by interacting with the “NO” button in the graphical user interface GUI, the route planner will update the planned route P to circumvent these road segments 7.

The road segments 7 may be shown simply as being associated with a driving difficulty. In an example, in case the driving difficulty is determined as one of a plurality of levels, the graphical user interface GUI is configured to also show the level of driving difficulty DD of each road segment 7. Such indication may be made using a color scheme, such as a medium driving difficulty DD is shown in orange color while a high driving difficulty DD is shown in red color.

Optionally, the graphical user interface GUI is indicating all road segments 7 for which a driving difficulty DD has been obtainer and which are present on the map 50. Hence, the selection of road segments 7 is in such example not linked with any planned route P, but the indicated road segments 7 will be updated as the map 50 is updated.

FIG. 3B shows another example of the graphical user interface GUI, at a situation where the host vehicle 1, travelling along the planned route P, is approaching an upcoming road segment 7 for which a driving difficulty DD has been obtained. At this situation, the graphical user interface GUI of the display 272 may be configured to prompt the driver to manually decide, by appropriate input to the graphical user interface GUI, if the assist system 200 of the host vehicle 1 is allowed to provide assistance when traversing the upcoming road segment 7.

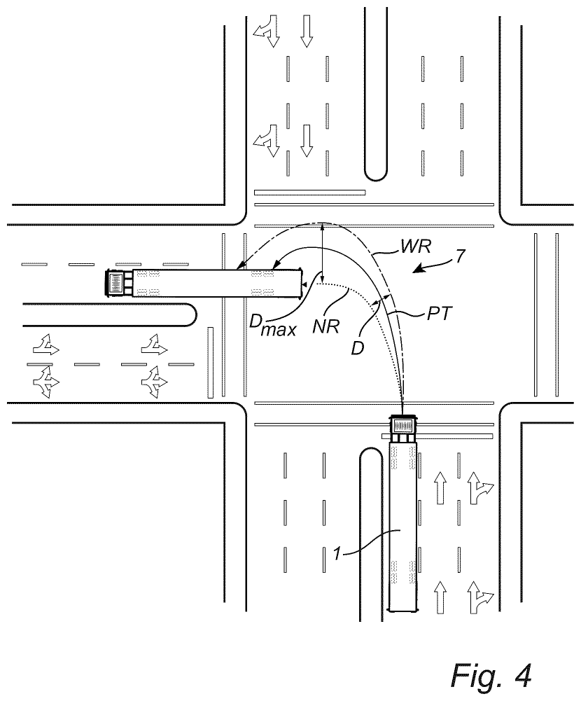

FIG. 4 shows an example of a host vehicle 1 traversing a left turn. In the shown example, the solid line PT indicates the most preferred trajectory for the host vehicle 1. However, for this road segment 7, i.e. the left turn, traversing data TD is stored representing previous traversals of vehicles. The traversing data TD comprises information of a previous vehicle traversing the road segment 7 along a narrow route NR indicated by the inner dashed line, as well as information of a previous vehicle traversing the road segment 7 along a wide route WR indicated by the outer dashed line. It should be realized that further traversing data TD may be stored for the road segment 7, comprising information of one or more previous vehicles traversing the road segment 7 along routes between the narrow route NR and the wide route WR. The narrow route NR and the wide route WR form outer boundaries of the traversing data TD for this road segment 7, and may be a result of less experienced drivers traversing the road segment 7. A distance D between these boundaries forms a variability band along the road segment 7. The distance D may for example extend normal to the preferred trajectory PT, or it may coincide with the radius of the turn of the road segment 7. By analyzing the variability band, and in particular the width of the variability band corresponding to the maximum distance Dₘₐₓ, it is possible to determine a driving difficulty associated with the road segment 7. Typically, a small maximum distance Dₘₐₓ corresponds to an increased driving difficulty DD, while a large maximum distance Dₘₐₓ corresponds to a reduced driving difficulty DD.

The width Dₘₐₓ of the variability band may be compared to some pre-determined threshold in order to determine a driving difficulty DD of the road segment 7. For example, the threshold may be a fixed value, or it may be a value which is relative to a specific parameter, such as lane width, length of the host vehicle 1, turn radius, etc. If the width Dₘₐₓ of the variability band is less than the threshold, an increased driving difficulty DD may be determined. Further, other parameters of the variability band may be used to determine the driving difficulty DD. Such parameter may e.g. include the length of the variability band (a short variability band may correspond to increased driving difficulty DD as less flexibility in driving is allowed).

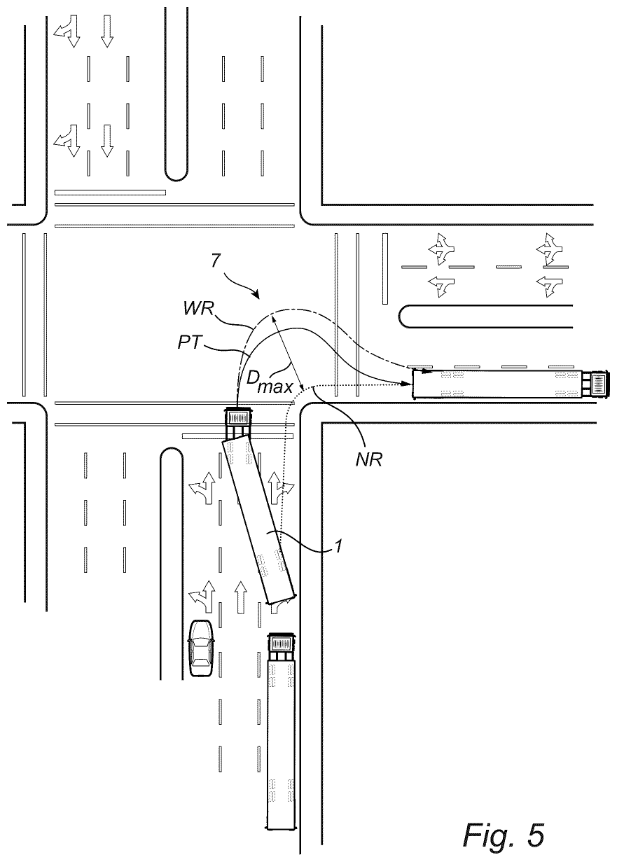

In FIG. 5 an example of a host vehicle 1 traversing a right turn is shown. In the shown example, the solid line PT indicates the most preferred trajectory for the host vehicle 1. The traversing data TD also comprises information of a previous vehicle traversing the road segment 7 along a narrow route NR indicated by the inner dashed line, as well as information of a previous vehicle traversing the road segment 7 along a wide route WR indicated by the outer dashed line. It should be noted that the narrow route NR will not be possible for the vehicle type of the host vehicle 1, but this traversing data TD may represent a smaller vehicle, such as a passenger car, traversing the road segment 7.

The preferred trajectory PT may be obtained from the variability band. In such example the preferred trajectory PT may be obtained by determining that a specific route is most frequent, as this would indicate that most vehicles chooses such trajectory when traversing the road segment 7. The preferred trajectory PT may in other examples be calculated based on existing formulas.

The narrow route NR and the wide route WR form outer boundaries of the traversing data TD. By analyzing the variability band, and in particular the width of the variability band corresponding to the maximum distance Dₘₐₓ, it is possible to determine a driving difficulty associated with the road segment 7.

Also in this case the width Dₘₐₓ of the variability band may be compared to some pre-determined threshold in order to determine a driving difficulty DD of the road segment 7. For example, the threshold may be a fixed value, or it may be a value which is relative to a specific parameter, such as lane width, length of the host vehicle 1, turn radius, etc.

For the examples described with reference to FIG. 4 and FIG. 5, the width Dₘₐₓ may indicate the required driving precision of the host vehicle 1 when traversing the upcoming road segment 7. Although the width Dₘₐₓ is easily identified as a significant parameter in the shown examples, the opposite may also occur; the width Dₘₐₓ being very small, thereby indicating that only a very small deviation in the trajectory is allowed in order to safely pass the road segment 7.

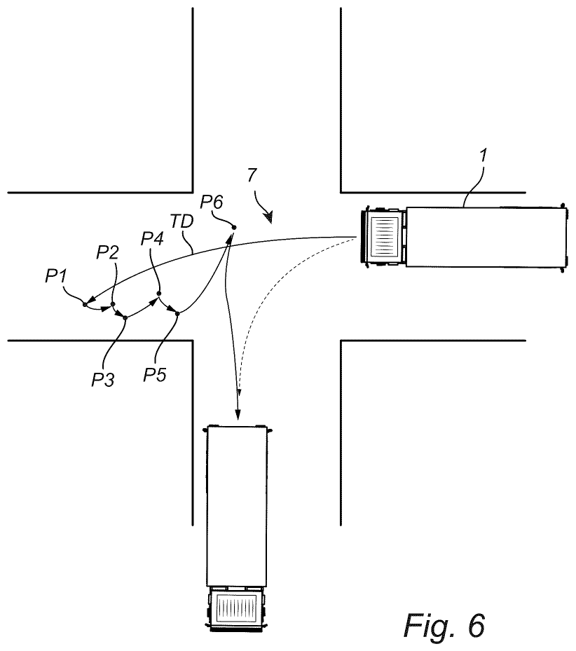

In FIG. 6 another example is shown. The host vehicle 1 is here to make a left turn at a narrow crossing, forming a road segment 7. Traversing data TD comprises information of a previous vehicle making the same left turn, indicated by the solid line. The traversing data TD comprises points P1-P6 of the multipoint turn required to traverse the crossing by the previous vehicle. These points P1-P6 thus represent, or indicate, the number of times the host vehicle 1 changes direction from forward to reverse or from reverse to forward when traversing the upcoming road segment 7. By recognizing one or more points P1-P6 in the traversing data TD it can be determined that the road segment 7 is associated with a driving difficulty DD.

For the example where the driving difficulty DD is determined as a non-binary variable, the number of points P1-P6 may be indicative of the level of difficulty; a higher number of points P1-P6 would thus correspond to a higher level of driving difficulty DD. As a further example, the driving difficulty DD may be determined based on the distance between two adjacent points P1-P6. As shown in FIG. 6, the distance between point P5 and point P6 is comparatively long, indicating that a considerable reverse driving is required in order to traverse the road segment 7. This may be associated with increased driving difficulty DD, as compared to if only very short reverse driving would be required (i.e. a small distance between point P5 and point P6). These two concepts (i.e. number of points P1-P6 and distance between adjacent points P1-P6) may be used independently, or they may be combined in order to determine an increased driving difficulty DD. An increased driving difficulty DD may be determined as an example only if i) the number of points P1-P6 is higher than a first threshold, and ii) the distance between two adjacent points P1-P6 is higher than a second threshold. Optionally, or in combination, an increased driving difficulty DD may be determined if the number of points P1-P6 is higher than a third threshold, no matter the distance between adjacent points P1-P6.

The preferred trajectory PT may be obtained from the number of points P1-P6. In such example the preferred trajectory PT may be obtained by determining a specific route comprising the least amount of points P1-P6, as this would indicate that such route would be most convenient for the driver of the host vehicle 1 when traversing the road segment 7.

Other options for obtaining the driving difficulty DD are also possible. For example, the driving difficulty DD of an upcoming road segment 7 may be obtained from a steering angle spread. The steering angle spread may be indicative of increased driving difficulty DD in a similar manner as the variability band explained above. For example, if the steering angle spread is large, meaning that previous traversals of the road segment 7 have been made using substantially different steering angles, this would correspond to no or low driving difficulty. If the steering angle spread is low, meaning that previous traversals have been made using substantially similar steering angles, this would correspond to increased or high driving difficulty DD. The steering angle spread may be included as steering data 80 (see FIG. 2B) in traversing data TD, and may be determined from the points P1-P6. A large steering angle spread, caused by forward and reverse operations between the points P1-P6 may indicate a significant driving difficulty. Alternatively, the steering angle spread may be determined from the width Dₘₐₓ of the variability band.

The driving difficulty DD of an upcoming road segment 7 may be obtained from a total number of braking operations for a vehicle traversing the road segment 7. The total number of braking operations may be included as braking data 82 (see FIG. 2B) in traversing data TD. An increased number of braking operations may thus correspond to a driving difficulty of the road segment 7.

Optionally, the driving difficulty DD may be obtained from a maximum and/or minimum speed of at least one vehicle of the vehicle type VT traversing the upcoming road segment 7. The maximum and/or minimum speed is in such example included as speed data 84 (see FIG. 2B) in the traversing data TD. A low maximum speed may indicate a driving difficulty, as well as a low minimum speed.

Finally, the driving difficulty DD may be obtained from a relationship between the maximum and/or minimum speed of at least one vehicle of the vehicle type VT traversing the upcoming road segment 7 and the maximum speed limit for the upcoming road segment 7. The relationship between the maximum and/or minimum speed and the maximum speed limit is in such example included as speed relationship data 86 (see FIG. 2B) in the traversing data TD. If the relationship is less than 1, that would indicate that significant braking is required in order to safely traverse the road segment 7.

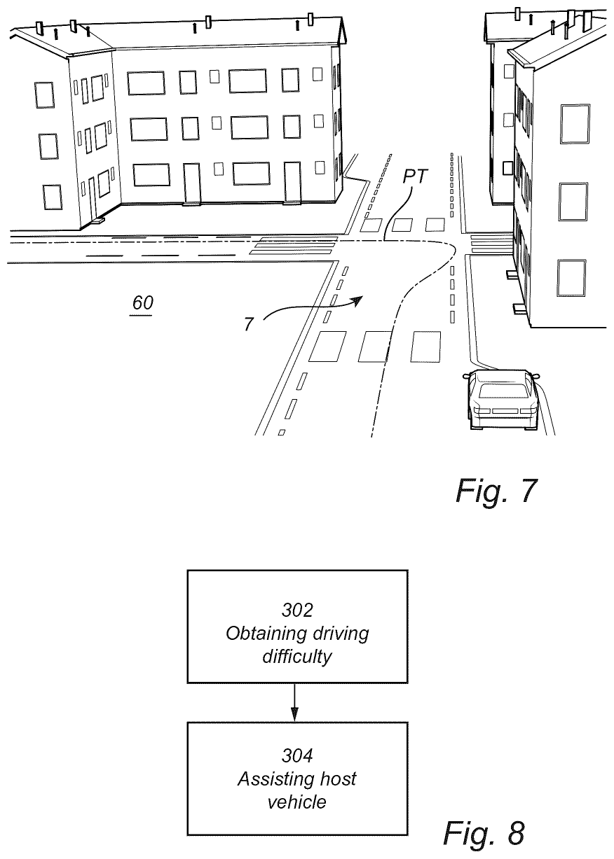

FIG. 7 shows the view of the driver of the host vehicle 1 when approaching a road segment 7. A driving difficulty DD is obtained for the road segment 7, and the driver is here assisted in traversing the road segment 7 by the use of a heads-up display 60 of the host vehicle 1. The heads-up display 60 is configured to project a preferred trajectory PT through the road segment 7, which the driver can choose to easily follow. Optionally, as described with reference to FIG. 2B, the assist system 200 may provide assistance by applying steering assist and/or at least semi-autonomous driving through the road segment 7.

FIG. 8 is a flow chart of a method 300 to assist a host vehicle 1 in traversing an upcoming road segment 7 according to an example. The method 300 comprises obtaining 302, by processing circuitry of a computer system, a driving difficulty of an upcoming road segment for a host vehicle of a vehicle type. The driving difficulty is based on at least one of: points of a multipoint turn of at least one vehicle of the vehicle type traversing the upcoming road segment; or a width of a variability band of a plurality of turning trajectories of at least one vehicle of the vehicle type traversing the upcoming road segment. The method 300 further comprises assisting 304 the host vehicle 1 in traversing the upcoming road segment 7.

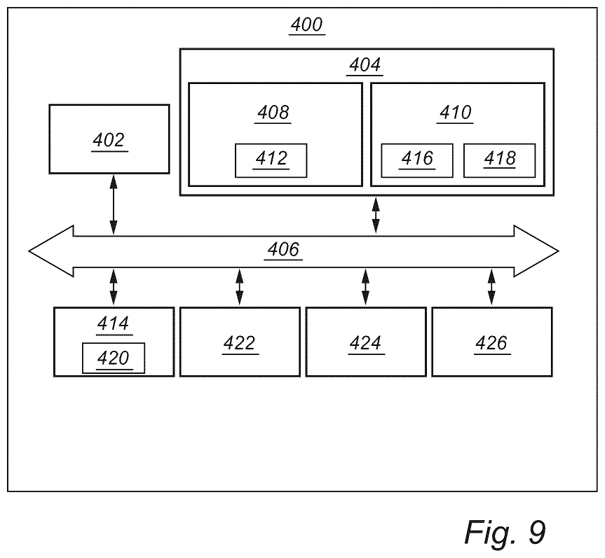

FIG. 9 is a schematic diagram of a computer system 400 for implementing examples disclosed herein. The computer system 400 is adapted to execute instructions from a computer-readable medium to perform these and/or any of the functions or processing described herein. The computer system 400 may be connected (e.g., networked) to other machines in a LAN (Local Area Network), LIN (Local Interconnect Network), automotive network communication protocol (e.g., FlexRay), an intranet, an extranet, or the Internet. While only a single device is illustrated, the computer system 400 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 400 may comprise at least one computing device or electronic device capable of including firmware, hardware, and/or executing software instructions to implement the functionality described herein. The computer system 400 may include processing circuitry 402 (e.g., processing circuitry including one or more processor devices or control units), a memory 404, and a system bus 406. The computer system 400 may include at least one computing device having the processing circuitry 402. The system bus 406 provides an interface for system components including, but not limited to, the memory 404 and the processing circuitry 402. The processing circuitry 402 may include any number of hardware components for conducting data or signal processing or for executing computer code stored in memory 404. The processing circuitry 402 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 402 may further include computer executable code that controls operation of the programmable device.

The system bus 406 may be any of several types of bus structures that may further interconnect to a memory bus (with or without a memory controller), a peripheral bus, and/or a local bus using any of a variety of bus architectures. The memory 404 may be one or more devices for storing data and/or computer code for completing or facilitating methods described herein. The memory 404 may include database components, object code components, script components, or other types of information structure for supporting the various activities herein. Any distributed or local memory device may be utilized with the systems and methods of this description. The memory 404 may be communicably connected to the processing circuitry 402 (e.g., via a circuit or any other wired, wireless, or network connection) and may include computer code for executing one or more processes described herein. The memory 404 may include non-volatile memory 408 (e.g., read-only memory (ROM), erasable programmable read-only memory (EPROM), electrically erasable programmable read-only memory (EEPROM), etc.), and volatile memory 410 (e.g., random-access memory (RAM)), or any other medium which can be used to carry or store desired program code in the form of machine-executable instructions or data structures and which can be accessed by a computer or other machine with processing circuitry 402. A basic input/output system (BIOS) 412 may be stored in the non-volatile memory 408 and can include the basic routines that help to transfer information between elements within the computer system 400.

The computer system 400 may further include or be coupled to a non-transitory computer-readable storage medium such as the storage device 414, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 414 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 414 and/or in the volatile memory 410, which may include an operating system 416 and/or one or more program modules 418. All or a portion of the examples disclosed herein may be implemented as a computer program 420 stored on a transitory or non-transitory computer-usable or computer-readable storage medium (e.g., single medium or multiple media), such as the storage device 414, which includes complex programming instructions (e.g., complex computer-readable program code) to cause the processing circuitry 402 to carry out actions described herein. Thus, the computer-readable program code of the computer program 420 can comprise software instructions for implementing the functionality of the examples described herein when executed by the processing circuitry 402. In some examples, the storage device 414 may be a computer program product (e.g., readable storage medium) storing the computer program 420 thereon, where at least a portion of a computer program 420 may be loadable (e.g., into a processor) for implementing the functionality of the examples described herein when executed by the processing circuitry 402. The processing circuitry 402 may serve as a controller or control system for the computer system 400 that is to implement the functionality described herein.

The computer system 400 may include an input device interface 422 configured to receive input and selections to be communicated to the computer system 400 when executing instructions, such as from a keyboard, mouse, touch-sensitive surface, etc. Such input devices may be connected to the processing circuitry 402 through the input device interface 422 coupled to the system bus 406 but can be connected through other interfaces, such as a parallel port, an Institute of Electrical and Electronic Engineers (IEEE) 1394 serial port, a Universal Serial Bus (USB) port, an IR interface, and the like. The computer system 400 may include an output device interface 424 configured to forward output, such as to a display, a video display unit (e.g., a liquid crystal display (LCD) or a cathode ray tube (CRT)). The computer system 400 may include a communications interface 426 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

Example 1: A computer system comprising processing circuitry configured to: obtain a driving difficulty (DD) of an upcoming road segment (7) for a host vehicle (1) of a vehicle type (VT), the driving difficulty (DD) based on at least one of: points (P1-P5) of a multipoint turn of at least one vehicle of the vehicle type (VT) traversing the upcoming road segment (7); or a width (Dₘₐₓ) of a variability band of a plurality of turning trajectories of at least one vehicle of the vehicle type (VT) traversing the upcoming road segment (7); wherein the processing circuitry is further configured to assist the host vehicle (1) in traversing the upcoming road segment (7).

Example 2: The computer system of Example 1, wherein the points (P1-P5) of a multipoint turn indicates forward and reverse operations by the host vehicle (1) in traversing the upcoming road segment (7).

Example 3: The computer system of Example 1 or 2, wherein the width (Dₘₐₓ) of the variability band indicates driving precision by the host vehicle (1) in traversing the upcoming road segment (7).

Example 4: The computer system of any of Examples 1-3, wherein assisting the host vehicle (1) in traversing the upcoming road segment (7) further comprises: obtain a preferred trajectory (PT) for the host vehicle (1), and assist the host vehicle (1) by guiding the host vehicle (1) along the preferred trajectory (PT).

Example 5: The computer system of Example 4, wherein assisting the host vehicle (1) by guiding the host vehicle (1) along the preferred trajectory (PT) further comprises at least one of: guide host vehicle (1) by visualizing the preferred trajectory (PT) to the driver; guide the host vehicle (1) by applying steering assist; or guide the host vehicle (1) by applying at least partly autonomous driving.

Example 6: The computer system of any of Examples 4-5, wherein the processing circuitry is further configured to: obtain the preferred trajectory (PT) from a plurality of reference trajectories, wherein each reference trajectory corresponds to a trajectory of at least one vehicle of the vehicle type (VT) traversing the upcoming road segment (7).

Example 7: The computer system of Example 6, wherein the processing circuitry is further configured to: obtain the variability band from the plurality of reference trajectories, and obtain the preferred trajectory (PT) based on the variability band.

Example 8: The computer system of any of Examples 6 or 7, wherein the processing circuitry is further configured to: obtain the points (P1-P5) of a multipoint turn from the plurality of reference trajectories, and obtain the preferred trajectory (PT) based on the total number of points (P1-P5) of the multipoint turn for each reference trajectory.

Example 9: The computer system of any of Examples 1-8, wherein obtaining the driving difficulty (DD) of an upcoming road segment (7) for the host vehicle (1) further comprises: obtain a steering angle spread of at least one vehicle of the vehicle type (VT) traversing the upcoming road segment (7) from the points (P1-P5) of the multipoint turn and/or from the width (Dₘₐₓ) of the variability band, and obtain the driving difficulty (DD) based on the steering angle spread.

Example 10: The computer system of any of Examples 1-9, wherein obtaining the driving difficulty (DD) of an upcoming road segment (7) for the host vehicle (1) further comprises: obtain a total number of braking operations of at least one vehicle of the vehicle type (VT) traversing the upcoming road segment (7), and obtain the driving difficulty (DD) based on the total number of braking operations.

Example 11: The computer system of any of Examples 1-10, wherein obtaining the driving difficulty (DD) of an upcoming road segment (7) for the host vehicle (1) further comprises: obtain the maximum and/or minimum speed of at least one vehicle of the vehicle type (VT) traversing the upcoming road segment (7), and obtain the driving difficulty (DD) based on the maximum and/or minimum speed.

Example 12: The computer system of any of Examples 1-11, wherein obtaining the driving difficulty (DD) of an upcoming road segment (7) for the host vehicle (1) further comprises: obtain a relationship between the maximum and/or minimum speed of at least one vehicle of the vehicle type (VT) traversing the upcoming road segment (7) and the maximum speed limit for the upcoming road segment (7), and obtain the driving difficulty (DD) based on the relationship.

Example 13: The computer system of any of Examples 1-12, wherein the processing circuitry is further configured to: indicate the upcoming road segment (7) on a map (50) of the host vehicle (1).

Example 14: The computer system of any of Examples 1-13, wherein the processing circuitry is further configured to: indicate the driving difficulty (DD) of the upcoming road segment (7) on a map (50) of the host vehicle (1).

Example 15: The computer system of any of Examples 1-14, wherein the processing circuitry is further configured to: obtain a skill level of the driver of the host vehicle (1), and to obtain the driving difficulty (DD) based on the driver's skill level.

Example 16: The computer system of each one of Examples 1-15, wherein the processing circuitry is further configured to store traversing data (TD) of the host vehicle (1) traversing the road segment (7).

Example 17: A vehicle (1) comprising the computer system of any of Examples 1-16.

Example 18: A computer-implemented method, comprising: obtaining (302), by processing circuitry of a computer system, a driving difficulty (DD) of an upcoming road segment (7) for a host vehicle (1) of a vehicle type (VT), the driving difficulty (DD) based on at least one of: points (P1-P5) of a multipoint turn of at least one vehicle of the vehicle type (VT) traversing the upcoming road segment (7); or a width (Dₘₐₓ) of a variability band of a plurality of turning trajectories of at least one vehicle of the vehicle type (VT) traversing the upcoming road segment (7); and assisting (304) the host vehicle (1) in traversing the upcoming road segment (7).

Example 19: The method of Example 18, wherein assisting (304) the host vehicle (1) in traversing the upcoming road segment (7) further comprises: obtaining a preferred trajectory (PT) for the host vehicle (1), and assisting (304) the host vehicle (1) by guiding the host vehicle (1) along the preferred trajectory (PT).

Example 20: A computer program product comprising program code for performing, when executed by the processing circuitry, the method of any of Examples 18-19.

Example 21: A non-transitory computer-readable storage medium comprising instructions, which when executed by the processing circuitry, cause the processing circuitry to perform the method of any of Examples 18-19.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

1. A computer system comprising processing circuitry configured to:
obtain a driving difficulty of an upcoming road segment for a host vehicle of a vehicle type, the driving difficulty based on at least one of:
points of a multipoint turn of at least one vehicle of the vehicle type traversing the upcoming road segment; and
a width of a variability band of a plurality of turning trajectories of at least one vehicle of the vehicle type traversing the upcoming road segment; and
assist the host vehicle in traversing the upcoming road segment.

2. The computer system of claim 1, wherein the points of a multipoint turn indicates forward and reverse operations by the host vehicle in traversing the upcoming road segment.

3. The computer system of claim 1, wherein the width of the variability band indicates driving precision by the host vehicle in traversing the upcoming road segment.

4. The computer system of claim 1, wherein assisting the host vehicle in traversing the upcoming road segment further comprises:
obtain a preferred trajectory for the host vehicle; and
assist the host vehicle by guiding the host vehicle along the preferred trajectory.

5. The computer system of claim 4, wherein assisting the host vehicle by guiding the host vehicle along the preferred trajectory further comprises at least one of:
guide host vehicle by visualizing the preferred trajectory to the driver;
guide the host vehicle by applying steering assist; or
guide the host vehicle by applying at least partly autonomous driving.

6. The computer system of claim 4, wherein the processing circuitry is further configured to:
obtain the preferred trajectory from a plurality of reference trajectories, wherein each reference trajectory corresponds to a trajectory of at least one vehicle of the vehicle type traversing the upcoming road segment.

7. The computer system of claim 6, wherein the processing circuitry is further configured to:
obtain the variability band from the plurality of reference trajectories; and
obtain the preferred trajectory based on the variability band.

8. The computer system of claim 6, wherein the processing circuitry is further configured to:
obtain the points of a multipoint turn from the plurality of reference trajectories; and
obtain the preferred trajectory based on the total number of points of the multipoint turn for each reference trajectory.

9. The computer system of claim 1, wherein obtaining the driving difficulty of an upcoming road segment for the host vehicle further comprises:
obtaining a steering angle spread of at least one vehicle of the vehicle type traversing the upcoming road segment from the points of the multipoint turn and/or from the width of the variability band; and
obtaining the driving difficulty based on the steering angle spread.

10. The computer system of claim 1, wherein obtaining the driving difficulty of an upcoming road segment for the host vehicle further comprises:
obtaining a total number of braking operations of at least one vehicle of the vehicle type traversing the upcoming road segment; and
obtaining the driving difficulty based on the total number of braking operations.

11. The computer system of claim 1, wherein obtaining the driving difficulty of an upcoming road segment for the host vehicle further comprises:
obtaining the maximum and/or minimum speed of at least one vehicle of the vehicle type traversing the upcoming road segment; and
obtaining the driving difficulty based on the maximum and/or minimum speed.

12. The computer system of claim 1, wherein obtaining the driving difficulty of an upcoming road segment for the host vehicle further comprises:
obtaining a relationship between the maximum and/or minimum speed of at least one vehicle of the vehicle type traversing the upcoming road segment and the maximum speed limit for the upcoming road segment; and
obtaining the driving difficulty based on the relationship.

13. The computer system of claim 1, wherein the processing circuitry is further configured to:
indicate the upcoming road segment on a map of the host vehicle and/or indicate the driving difficulty of the upcoming road segment on a map of the host vehicle.

14. The computer system of claim 1, wherein the processing circuitry is further configured to:
obtain a skill level of the driver of the host vehicle, and to obtain the driving difficulty based on the driver's skill level.

15. The computer system of claim 1, wherein the processing circuitry is further configured to store traversing data of the host vehicle traversing the road segment.

16. The computer system of claim 1, wherein:
the points of a multipoint turn indicates forward and reverse operations by the host vehicle in traversing the upcoming road segment;
the width of the variability band indicates driving precision by the host vehicle in traversing the upcoming road segment;
assisting the host vehicle in traversing the upcoming road segment further comprises:
obtaining a preferred trajectory for the host vehicle; and
assisting the host vehicle by guiding the host vehicle along the preferred trajectory by at least one of:
guiding the host vehicle by visualizing the preferred trajectory to the driver;
guiding the host vehicle by applying steering assist; or
guiding the host vehicle by applying at least partly autonomous driving;
the processing circuitry is further configured to:
obtain the preferred trajectory from a plurality of reference trajectories, wherein each reference trajectory corresponds to a trajectory of at least one vehicle of the vehicle type traversing the upcoming road segment;
obtain the variability band from the plurality of reference trajectories;
obtain the preferred trajectory based on the variability band;
obtain the points of a multipoint turn from the plurality of reference trajectories;
obtain the preferred trajectory based on the total number of points of the multipoint turn for each reference trajectory;
indicate the upcoming road segment on a map of the host vehicle; and
store traversing data of the host vehicle traversing the road segment.

17. A vehicle comprising the computer system of claim 1.

18. A computer-implemented method, comprising:
obtaining, by a processing circuitry of a computer system, a driving difficulty of an upcoming road segment for a host vehicle of a vehicle type, the driving difficulty based on at least one of:
points of a multipoint turn of at least one vehicle of the vehicle type traversing the upcoming road segment; and
a width of a variability band of a plurality of turning trajectories of at least one vehicle of the vehicle type traversing the upcoming road segment; and
assisting the host vehicle in traversing the upcoming road segment.

19. A computer program product comprising program code for performing, when executed by the processing circuitry, the method of claim 18.

20. A non-transitory computer-readable storage medium comprising instructions, which when executed by the processing circuitry, cause the processing circuitry to perform the method of claim 18.
